(19) United States
(12) Patent Application Publication
(10) Pub. No.: US 2006/0209686 A1
(43) Pub. Date: Sep. 21, 2006

(54) Flow control with dynamic priority allocation for handover calls

(75) Inventors: Jeroen Wigard, Klarup (DK); Klaus Ingemann Pedersen, Aalborg (DK)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/134,378

(22) Filed: May 23, 2005

(30) Foreign Application Priority Data
Mar. 15, 2005 (EP) 05005650.6

(51) Int. Cl. H04L 12/26; H04Q 7/00; H04L 1/00

(52) U.S. Cl. 370/229; 370/331

(57) ABSTRACT

The present invention relates to a flow control method and apparatus for scheduling data packets in a high-speed time-shared channel, wherein a scheduling priority is dynamically increased for a predetermined time period for users in a handover state. Thereby, transmission gaps caused by empty buffers in the handover target device can be avoided. Moreover, cell capacity can be increased due to improved multi user diversity.

### FIELD OF THE INVENTION

The present invention relates to a flow control method and apparatus for scheduling high-speed packet data in time-shared channels.

### BACKGROUND OF THE INVENTION

To satisfy increasing demands for high-speed packet data in UMTS Terrestrial Radio Access Networks (UTRANs), as described for example in the 3GPPP specification TS 25.308, emerging standards for next-generation DSCDMA (Direct Sequence Code Division Multiple Access) systems are currently extended to cope with higher data rates. Both suggested High Data Rate (HDR) and High Speed Downlink Packet Access (HSDPA) modes consider a time-divided downlink. One key issue for better utilization of scarce radio resources is an appropriate scheduling of users in order to enhance the throughput. Hence, rate control and time-division scheduling algorithms are used in forwarding packet data transmission to utilize the radio resource effectively and support the high transmission rate.

Employing an efficient packet scheduling algorithm is an essential technique in order to improve the total system throughput as well as the peak throughput of each access user. Although always scheduling the user with the highest link quality may maximise capacity, it can result in a performance too unfair among the users.

The proportional fair scheduling method assigns transmission packets based on criteria such as a ratio between an instantaneous signal-to-interference power ratio (SIR) and a long-term average SIR value of each user. Another well-known proportional fair scheduling algorithm is the so-called proportional fair throughput (PFT) algorithm which provides a trade-off between throughput maxi-misation and fairness among users within a cell. In the traditional framework, the PFT algorithm selects the user to be scheduled during the next transmission time interval (TTI) according to a priority metric, which can be expressed as:
Pₙ=Rₙ/Tₙ

for a user numbered n, where Rₙ denotes the throughput which can be offered to user n during the next TTI where this user is scheduled, and Tₙ denotes the mean or average throughput delivered to this user within a predetermined time period. It is noted that the value Rₙ is typically time-variant as it depends on the SIR value of this user.

HSDPA is based on techniques such as adaptive modulation and Hybrid Automatic Repeat Request (HARQ) to achieve high throughput, reduced delay and high peak rates. It relies on a new type of transport channel, i.e. the High Speed Downlink Shared Channel (HS-DSCH), which is terminated in the Node B. The Node B is the UMTS equivalent to base station in other cellular networks. The priority metric Pₙ is calculated for all users sharing the time-multiplexed channel, e.g. the Downlink Shared Channel (DSCH) or the High Speed Downlink Shared Channel (HS-DSCH) as described in the 3GPP (third generation Partnership Project) specification TS 25.308 V5.4.0. The user with the largest calculated or determined priority metric is selected to be scheduled during the next TTI. Hence, if the user n has not been scheduled for a long period of time, the monitored average throughput Tₙ will decrease and consequently cause an increase of the priority Pₙ of said user.

The new functionalities of HARQ and HS-DSCH scheduling are included in the MAC layer. In UTRAN, these functions are included in a new entity called MAC-hs 10 located in the Node B. However, the other Layer 2 functionalities, like RLC (Radio Link Control), MAC-d and MAC-c/sh, are located in the RNC (Radio Network Controller). A flow control function is used in order to transfer data from the RNC to the Node-B. The flow control part at the Node-B monitors the queues in the Node-B and requests data from the RNC. The flow control part in the RNC can fulfil the request or it can send less than the amount of data requested. One reason for sending less may be that the lub capacity is less than the total requested data by the Node-B (the Node-B is not aware of the available capacity on the lub).

In order to get full benefit from scheduling methods like proportional fair scheduling, as many users as possible need to have data in their Node-B buffers. That way a multi user diversity gain is achieved.

HSDPA uses hard handover, so when a handover is triggered, the connection between the ‘old’ Node-B is released and a connection to the target Node-B is set up. This can lead to a gap in the transmission, since data from the RNC has to be put in the target Node-B in order to be able to transmit it to the user. Thus, during the HSDPA handover, a period with an empty user buffer may occur, which leads to worse user experience and lower cell throughput.

At the same time, transport resources are often the bottleneck in the system (instead of for instance the air interface resources).

### SUMMARY OF THE INVENTION

It is therefore an object of the present invention to provide an improved flow control mechanism, by means of which transmission gaps can be avoided during handover states.

This object is achieved by a flow control method for scheduling data packets in a multiplexed high-speed channel, said method comprising the steps of:
determining a scheduling priority for a user based on a predetermined scheduling algorithm; and
dynamically increasing said determined scheduling priority for a predetermined time period in response to the detection of a handover state of said user.

Furthermore, the above object is achieved by A flow control apparatus for scheduling data packets in a multiplexed high-speed channel, said apparatus comprising:
priority determination means for determining a scheduling priority for a user based on a predetermined scheduling algorithm; and
dynamic priority change means for dynamically increasing said determined scheduling priority in response to the detection of a handover state of said user.

Accordingly, an increased priority is dynamically allocated to handover calls or users in a handover state. Transmission gaps caused by empty buffers in the handover target device can therefore be minimized due to the fact that the data of these users is directly passed to the handover target cell in cases of congestion. This leads to an improved end user quality. Even in non-congestion cases this principle can be used, so that data of users in handover state is first passed to the target cell. Moreover, cell capacity can be increased due to improved multi user diversity.

As an example, the highest or one but highest priority may be reserved for handover calls, and the scheduling priority can then be increased to said reserved priority.

The handover state of a user could be detected for example by using an RRC signalling.

The dynamic priority increase may be performed before the first data packet has arrived at a handover target device. Then, a slow response due to slow signalling of the handover state does not affect the benefits of the proposed solution.

As an additional option, a connection to a handover target cell can be set up and flow control can be started in the target cell prior to an activation time of the handover. Thereby, it is possible that some data already exists in the buffer of the target cell when data transmission starts in the target cell.

Further advantageous modifications are defined in the dependent claims.

### BRIEF DESCRIPTION OF THE DRAWINGS

In the following, the present invention will be described in greater detail based on preferred embodiments with reference to the accompanying drawings, in which:

FIG. 1 shows a schematic functional block diagram of a MAC-hs unit with a packet scheduler which can be used in connection which the preferred embodiment; and

FIG. 2 shows a schematic functional block diagram of a flow control scheme according to the preferred embodiment.

### DESCRIPTION OF THE PREFERRED EMBODIMENTS

The preferred embodiment will now be described based on a Medium Access Control (MAC) architecture for a Node B device

In the Node B device, the transport channel HS-DSCH is controlled by a MAC-hs 10. For each TTI of the HS-DSCH, each shared control channel (HS-SCCH) carries HS-DSCH related downlink signalling for one user equipment (UE) which is the UMTS equivalent to the mobile station or mobile terminal in other cellular networks. Data received on the HS-DSCH is mapped to the MAC-hs 10. The MAC-hs 10 is configured by a Radio Resource Control (RRC) function to set the parameters according to the allowed transport format combinations for the HS-DSCH. Associated downlink signalling (ADS), e.g. associated Dedicated Physical Channel (DPCH), carries information for supporting the HS-DSCH and associated uplink signalling (AUS) carries feedback information. As to the AUS, it may be distinguished between the associated DPCH and the HS-DPCCH (High Speed Dedicated Physical Control Channel) which is the channel carrying the acknowledgements for packet data units (PDUs) received on the HS-DSCH. If a HS-DSCH is assigned to the concerned UE, PDUs to be transmitted are transferred to the MAC-hs 10 via respective lu interfaces to provide the required scheduling function for the common HS-DSCH.

The MAC-hs 10 is responsible for handling the data transmitted on the HS-DSCH. Furthermore, it is responsible for the management of physical resources allocated to the HS-DSCH. To achieve this, the MAC-hs 10 receives configuration parameters via messages of the Node B Application Part (NBAP).

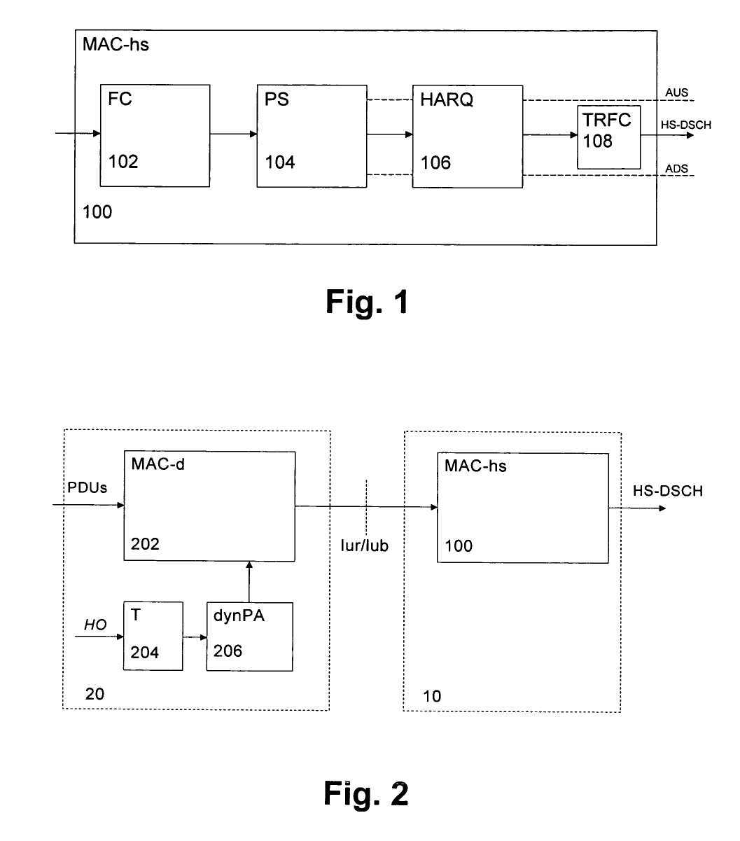

According to FIG. 1, the MAC-hs 10 comprises four different functional entities. A flow control unit 102 provides a flow control function intended to limit layer 2 signalling latency and reduce discarded and transmitted data as a result of HS-DSCH congestion. Flow control is provided independently per priority class for each MAC flow. Furthermore, a packet scheduling unit 104 is provided which manages HS-DSCH resources between HARQ entities and data flows according to their priority class. Based on status reports from associated uplink signalling, e.g. HS-DPCCH signalling, either new transmission or retransmission is determined. Further, the priority class identifiers and transmission sequence numbers are set for each new data block being served. To maintain proper transmission priority, a new transmission can be initiated on a HARQ process at any time. The transmission sequence number is unique to each priority class within a HS-DSCH, and is incremented for each new data block. It is not permitted to schedule new transmissions within the same TTI, along with retransmission originating from the HARQ layer.

A subsequent HARQ unit 106 comprises HARQ entities, wherein each HARQ entity handles the HARQ functionality for one user. One HARQ entity is capable of supporting multiple instances of stop and wait HARQ protocols. In particular, one HARQ process may be provided per TTI.

Finally, a Transport Format Resource Combination (TFRC) selection unit 108 is provided for selecting an appropriate transport format and resource combination for the data to be transmitted on the HS-DSCH.

In the following, a flow control functionality with dynamic priority allocation or setting is described.

FIG. 2 shows a schematic functional block diagram of the proposed flow control functionality or mechanism implemented at an RNC 20.

The RNC 20 comprises a MAC-d unit 202 in which a priority class is set individually for each MAC-d flow which is a flow of MAC-d PDUs which belong to logical channels which are MAC-d multiplexed. One HS-DSCH can transport several priority classes. The priority class is modified to dynamically increase the allocated priority for handover calls, i.e. during a handover situation. This can be achieved by providing a timer unit 204 to which an information HO indicating a handover call is supplied, e.g. from respective determination functions (not shown) provided from the MAC-d 202 or another RNC function or external network function. The timer unit 204 generates a temporary control signal during which a dynamical priority allocation function 206 increases the allocated priority class of the concerned MAC-d flow to a reserved higher priority class dedicated to handover calls. Both or one of the timer unit 204 and the dynamical priority allocation function 206 can be implemented as discrete hardware units or as software routines based on a which a processing unit is controlled. Furthermore, the timer unit 204 and the dynamical priority allocation function 206 may be implemented as integrated functions of the MAC-d unit 202.

The MAC-d flows with their allocated priority classes are forwarded over the lur/lub interface to the MAC-hs unit 100 of a Node B 10 of a handover target cell. Hence, in case of congestion, the data of handover users (users in a handover situation) are most likely to be passed from the RNC 20 to the target Node B 10.

A priority selection function at the target Node B 10 is arranged to select one of a plurality of priority buffers to which respective priority classes are allocated. Data packets supplied to the same priority buffer have the same allocated priority class. As long as a buffer with a higher priority class stores a data packet, data packets in priority buffers of lower priority classes are not forwarded towards the common HS-DSCH.

The highest or at least a high priority in the flow control mechanism of the MAC-d unit 202 is thus reserved for handover users, such that: in case of congestion, the data of these users is quickly passed from the RNC 20 to the Node-B 10. Also in case of non congestion this principle can be used, such that the data of the handover users is sent first or alt least at reduced delay to the Node-B 10. The implementation can be done by using dynamic priorities changed is response to a control signal supplied from the dynamic priority allocation function 206.

According to a specific example, the highest or one but highest priority is reserved for handover calls. In case data with this priority arrives in the MAC-hs buffer 100 of the Node-B 10, this data is treated as high priority data, i.e. the data gets served before other lower piority data. After a predetermined period (e.g. PendingTimeHighPriorityHO), counted by the timer function 204, the reserved priority is set to the original lower priority. The priority change operation can be based on RRC signalling and may thus be rather slow. This however does not affect the benefits of the dynamic priority. The change of the priority can be slowly dynamic, as long as the change of the priority is done before the first data packet arrives at the new or target Node-B 10. This can be achieved, since the RNC 20 has knowledge about this situation.

As an additional mechanism for solving the transmission gap problem, e.g. during a handover situation, the RNC 20 may define the activation time for the exact change from the source cell to the target cell. Before the activation time, the connection to the target cell is then setup already. So, the flow control in the target cell can start before the activation time. Then, some data can already exist in MAC-hs buffer of the Node B 10 of the target cell when the data transmission is started in the target cell (i.e. at the activation time). This additional mechanism can be combined with other above dynamic priority mechanism.

The proposed flow control scheme provides a possibility to improve HSDPA performance. HSDPA UEs in handover state will have highest priority for flow control and packet scheduling operations over a certain time period. Thereby, flow control and packet scheduling delays during handovers can be prevented or at least reduced, which in turn improves QoS and system performance.

In summary, a flow control method and apparatus for scheduling data packets in a high-speed time-shared channel is suggested, wherein a scheduling priority is dynamically increased for a predetermined time period for users in a handover state. Thereby, transmission gaps caused by empty buffers in the handover target device can be avoided to improve end user quality. Moreover, cell capacity can be increased due to improved multi user diversity.

It is noted that the present invention is not restricted to the above HSDPA-related flow control mechanism with dynamic priority setting for handover calls. The present invention can be applied to any flow control or scheduling mechanism in order to improve data throughput for handover calls. In particular, the present invention can be applied to any DSCH or HSDPA scheduling algorithm or other scheduling algorithms in all kinds of data packet connections. As an alternative option, the timer unit 204 and the dynamical priority allocation function 206 may be implemented within the Node B 10 or any other base station device, so that at least the throughput at the target cell can be increased in response to a determined handover situation. The preferred embodiments may thus vary within the scope of the attached claims.

1. A flow control method for scheduling data packets in a multiplexed high-speed channel, said method comprising the steps of:
a) determining a scheduling priority for a user based on a predetermined scheduling algorithm; and
b) dynamically increasing said determined scheduling priority for a predetermined time period in response to the detection of a handover state of said user.

2. A method according to claim 1, further comprising the steps of reserving the highest or one but highest priority for handover calls, and increasing said scheduling priority in step (b) to said reserved priority.

3. A method according to claim 1, signalling said detected handover state by using an radio resource control (RRC) signalling.

4. A method according to claim 1, wherein step (b) is performed before the first data packet has arrived at a handover target device.

5. A method according to claim 1, further comprising the steps of setting up a connection to a handover target cell, and starting flow control in a target cell prior to an activation time of a handover.

6. A method according to claim 1, wherein said flow control method is used for high speed downlink packet (HSDPA) packet scheduling in a medium access control (MAC) unit of a radio network controller device.

7. A flow control apparatus for scheduling data packets in a multiplexed high-speed channel, said apparatus comprising:
a) priority determination means for determining a scheduling priority for a user based on a predetermined scheduling algorithm; and
b) dynamic priority change means for dynamically increasing said determined scheduling priority in response to the detection of a handover state of said user.

8. An apparatus according to claim 7, wherein said priority determination means is configured to reserve the highest or one but highest priority for handover calls, and to increase said scheduling priority to said reserved priority in response to an output of said dynamic priority change means.

9. An apparatus according to claim 7, wherein said dynamic priority change means is configured to detect said handover state based on an radio resource control (RRC) signalling.

10. An apparatus according to claim 7, wherein said dynamic priority change means is configured to perform said dynamic increase before the first data packet has arrived at a handover target device.

11. An apparatus according to claim 7, wherein said apparatus is configured to set up a connection to a handover target cell, and to start flow control in a target cell prior to an activation time of a handover.

12. An apparatus according to claim 7, wherein said flow control apparatus is a radio network controller device.

13. A flow control system for scheduling data packets in a multiplexed high-speed channel, said system comprising:
a) priority determination unit for determining a scheduling priority for a user based on a predetermined scheduling algorithm; and
b) dynamic priority change unit for dynamically increasing said determined scheduling priority in response to the detection of a handover state of said user.

14. A system according to claim 13, wherein said priority determination unit is configured to reserve the highest or one but highest priority for handover calls, and to increase said scheduling priority to said reserved priority in response to an output of said dynamic priority change unit.

15. A system according to claim 13, wherein said dynamic priority change unit is configured to detect said handover state based on an radio resource control (RRC) signalling.

16. A system according to claim 13, wherein said dynamic priority change unit is configured to perform said dynamic increase before the first data packet has arrived at a handover target device.

17. A system according to claim 13, wherein said system is configured to set up a connection to a handover target cell, and to start flow control in a target cell prior to an activation time of a handover.

18. A system according to claim 13, wherein said flow control system is a radio network controller device.
